(19) United States
(12) Patent Application Publication
(10) Pub. No.: US 2007/0201529 A1
(43) Pub. Date: Aug. 30, 2007

(54) Optical oxygen laser and method

(76) Inventors: David Kurt Neumann, Colorado Springs, CO (US); Thomas Lee Henshaw, Monument, CO (US)

Correspondence Address: LAW OFFICE OF DALE B. HALLING, LLC, 655 SOUTHPOINTE CT, SUITE 100, COLORADO SPRINGS, CO, 80906, US

(21) Appl. No.: 10/670,689

(22) Filed: Sep. 25, 2003

Related U.S. Application Data
(63) Continuation-in-part of application No. 10/198,594, filed on Jul. 18, 2002, now Pat. No. 6,658,038.

(51) Int. Cl. H01S 3/22; H01S 3/223

(52) U.S. Cl. 372/55

(57) ABSTRACT

An optical oxygen laser has a source of oxygen. A cryoreactor has an input connected to the source of oxygen. An optical pump is coupled to the cryoreactor and excites the oxygen to form an singlet delta oxygen, an excited state of oxygen. An optical resonator cavity receives the excited state oxygen and has a laser output.

### RELATED APPLICATIONS

This patent claims priority from and is a continuation-in-part of the U.S. patent application entitled “System for Producing Singlet Delta Oxygen Laser”, filed on Jul. 18, 2002 and having application Ser. No. 10/198,594 and assigned to the same assignee as the present application.

### STATEMENT REGARDING FEDERALLY SPONSORED RESEARCH OR DEVELOPMENT

This invention was made with Government support under contract DAS60-0-C-0025 awarded by U.S. Army Space and Missile Defense Command. The Government has certain rights in the invention

### FIELD OF THE INVENTION

The present invention relates generally to the field of lasers and more particularly to an optical oxygen laser and method.

### BACKGROUND OF THE INVENTION

Singlet delta oxygen has a number of uses in lasers, medicine, bio-decontamination and high temperature superconductors. One method of producing singlet delta oxygen in high percentages relative to ground state oxygen is a chemical generation process. This method is commonly associated with chemical lasers where iodine is used to extract energy stored in the singlet delta oxygen and is the optically active species in the laser. The lasing wavelength for this laser is 1315 nm in a region of the spectrum which presents a potential eye hazard and limitations on propagation through the atmosphere.

Thus there exists a need for a system and method producing high densities of singlet delta oxygen that does not require large weight and volume devices, does not consume large quantities of explosive and toxic chemicals, and operates as a laser in a region of the spectrum which has a greater degree of eye safety and propagates well through the atmosphere. A device which produces high densities of singlet delta oxygen enables the generation of laser light on one of the optical transitions in the oxygen at 1580 nm which is a wavelength that is relatively eye safe and propagates through the atmosphere.

### BRIEF DESCRIPTION OF THE DRAWINGS

FIG. 1 is a block diagram of a system for producing singlet delta oxygen which may be used in a laser in accordance with one embodiment of the invention;

FIG. 2 is a block diagram of an optical oxygen iodine laser in accordance with one embodiment of the invention;

FIG. 3 is a an optical pumping system for a system for producing singlet delta oxygen in accordance with one embodiment of the invention;

FIG. 4 is a cross section of a reactor for use in a system for producing singlet delta oxygen in accordance with one embodiment of the invention;

FIG. 5 is a flow chart of a system for producing singlet delta oxygen which may be used in a laser in accordance with one embodiment of the invention; and

FIG. 6 is a cross sectional view of an optical oxygen laser in accordance with one embodiment of the invention;

FIG. 7 is a side cross sectional view of light interaction region of the optical oxygen laser of FIG. 1 in accordance with one embodiment of the invention;

FIG. 8 is a front cross sectional view looking into the A-A line of the light interaction region shown in FIG. 1 in accordance with one embodiment of the invention; and

FIG. 9 is schematic view of the optical pump source and optics in accordance with one embodiment of the invention.

### SUMMARY OF THE INVENTION

An optical oxygen laser includes a source of oxygen. A cryoreactor has an input connected to the source of oxygen. An optical pump is coupled to the cryoreactor. The optical pump excites the source of oxygen to form an excited state of oxygen. An optical resonator cavity receives the excited state oxygen and has a laser output.

In one embodiment, the source of oxygen is a liquid oxygen. In another embodiment, the source of oxygen is a supercritical oxygen. The source of oxygen is pressurized. The pressure of the source of oxygen is between two and ninety atmospheres.

In one embodiment, the optical pump source is a diode array. The diode array is coupled through an optical element to an optical fiber. In one embodiment, the diode array is bathed in the source of oxygen.

In one embodiment, the cryoreactor includes an intake manifold, a waveguide and an exhaust manifold. The waveguide has an optical input. An exhaust pipe is coupled to the exhaust manifold. The pressure in the exhaust pipe is less than a pressure of the source of oxygen.

In one embodiment, a method of operating an optical oxygen laser includes the steps of illuminating a volume of oxygen with an optical pump source in a reactor to form an excited state of oxygen. Placing the excited state of oxygen in an optical resonant cavity which has a laser output. Exhausting a decayed state of oxygen from the optical resonant cavity. In one embodiment, the step of illuminating includes powering a ytterbium doped fiber laser. In another embodiment, the step of illuminating includes powering a Raman fiber laser.

In one embodiment, the method of operating an optical oxygen laser includes cooling the optical pump with a source of oxygen.

In one embodiment, an optical oxygen laser includes an optical pump. A reactor is coupled to a source oxygen. The reactor combines a volume of oxygen from the source of oxygen with a light from the optical pump to form an excited state of oxygen. An optical resonant cavity receives the excited state of oxygen and has a laser output. In one embodiment, the reactor has a waveguide where the light and the volume of oxygen are combined. A pair of mirrors are placed at each end of the waveguide.

In one embodiment, the optical pump includes a laser diode array.

### DETAILED DESCRIPTION OF THE DRAWINGS

An optical oxygen laser includes a source of high density molecular oxygen. A portion of the ground state, molecular oxygen, O₂(X³_), is excited by an optical source to the so called singlet delta state, O₂(a¹_). A state of population inversion then exists between the O₂(a¹_), v′=0 (zeroth vibrational level) and O₂(X³_), v″=1 (first vibrational level) states. Stimulated emission on the transition between these two states produces coherent light output at 1580 nm. Bottlenecking on the lower laser level is eliminated by (1) vibrational relaxation with He or another rapid deactivator of this state or (2) flow of the molecules in this state out of the active region of the resonator. In its liquid state oxygen has a substantial heat of vaporization. This vaporization energy can be employed for laser waste heat thermal control as well as optical source temperature stabilization and waste heat elimination. The laser, therefore, has a unique property of dual use of its optically active medium as its coolant.

Because of molecular oxygen's small cross section for absorption of light and low stimulated emission cross section, high densities of oxygen are required to achieve gains necessary for efficient laser operation and power extraction. High densities of oxygen can be obtained by high pressure in combination with temperatures below room temperature (supercritical oxygen) or pressure below atmospheric in combination with cryogenic temperatures (liquid oxygen). In these cases, an oxygen density greater than 10²²/cm³ can be obtained.

With an adequate density of oxygen, light resonant with optical transitions in molecular oxygen can efficiently convert ground state oxygen, O₂(X³_), to singlet delta oxygen, O₂(a¹_). Transitions which couple the ground state to the excited state exist at a variety of wavelengths including 635 nm, 1065 nm, and 1270 nm. The linewidth of these transitions is typically greater than 10 nm. At high density, both mono- and bi-molecular transitions can participate in the production of singlet delta oxygen.

At liquid oxygen densities, absorption lengths on these transitions are about one centimeter. Therefore, light sources such as diodes (635 nm), fiber lasers (1067 nm) and Raman fiber lasers (1270 nm) offer ideal high intensity optical pump sources.

To promote about 1% of the oxygen to the singlet delta state in a typical excitation time period of 10 microseconds, a light intensity of 10 MW/cm² is needed. Therefore, high intensity light sources are key to enabling laser operation. One-percent singlet delta oxygen at liquid oxygen density results in a gain of about 1%/cm on the optical transition at 1580 nm and an extractable power of about 32 J/cm³.

This is the first molecular oxygen laser ever designed. Because of its high power operation, extremely compact nature, excellent atmospheric propagation, and eye safe wavelength, it may find many uses in material processing, oil well drilling, and directed energy applications.

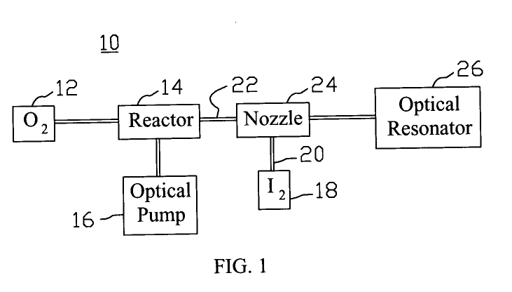

An optical oxygen laser requires generating an excited state of oxygen. FIG. 1 is a block diagram of a system 10 for producing singlet delta oxygen, which may be used in a laser in accordance with one embodiment of the invention. The system 10 has a source of oxygen 12. In one embodiment the source of oxygen is a liquid oxygen. In another embodiment, the source of oxygen is a high pressure oxygen. The source of oxygen 12 is connected to an input of a reactor (cyroreactor) 14. An optical pump source 16 is coupled to the reactor 14. A source of molecular iodine 18 has an output 20 adjacent to an output 22 of the reactor 14, in one embodiment used to produce a laser. The iodine 18 combines with the singlet delta oxygen in a nozzle 24. In one embodiment, an optical resonator cavity 26 is placed near the output of the nozzle 24 to form a laser. In one embodiment the optical pump source is a ytterbium doped fiber laser. In another embodiment the optical pump source is a group of laser diodes.

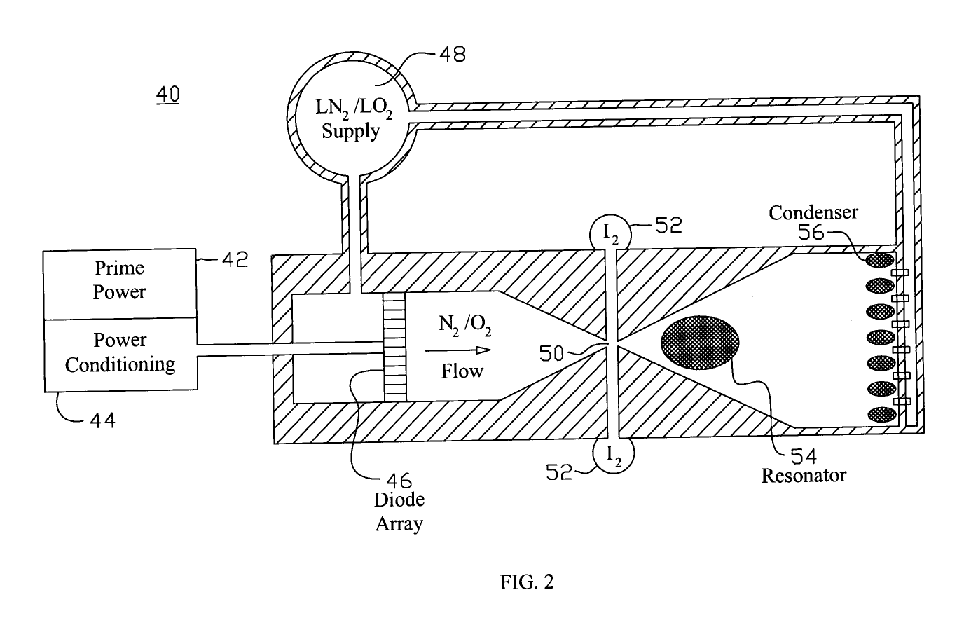

FIG. 2 is a block diagram of an optical oxygen iodine laser 40 in accordance with one embodiment of the invention. The laser 40 has a power source which includes a prime power source 42 and a power conditioning system 44. A diode array 46 is the optical excitation source. The diode array 46 produces a broadband emission around 634 nm in one embodiment. The diodes are cooled and temperature controlled by a combined flow of liquid nitrogen and liquid oxygen 48. The light source illuminates the liquid nitrogen and oxygen and produces a high percentage of singlet delta oxygen by the process

O₂(³Σ, v″=0) O₂(³Σ, v″=0)→O₂(¹Δ, v′=0) O₂(¹Δ, v′=0) Heat released from the reaction along with heat from the diode array provides the necessary heat to convert the liquid to a gas. The gas phase O₂(¹Δ) is allowed to expand into a volume sized to achieve an operating pressure of several atmospheres. This high pressure is used to drive a supersonic expansion through the nozzle 50. Molecular iodine 52 is mixed with the excited oxygen at the nozzle 50. The molecular iodine dissociates in the presence of the oxygen by collisions with the singlet sigma or singlet delta oxygen. A population inversion is obtained by the iodine atom collisions with the singlet delta oxygen and the resulting energy transfer reactions. An optical resonator 54 is placed across the output of the nozzle 50 and extracts optical energy from the gas flow by stimulated emission. A condenser 56 is used to collect the oxygen and nitrogen for reuse. In one embodiment, the light source is a Nd:YAG laser operating at 1060 nm or a ytterbium doped fiber laser.

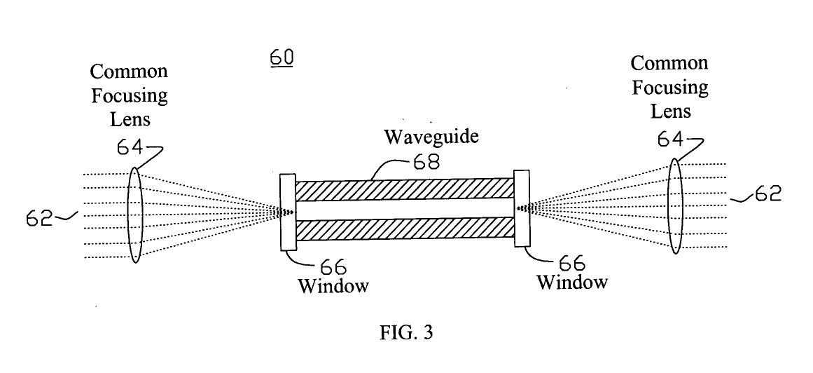

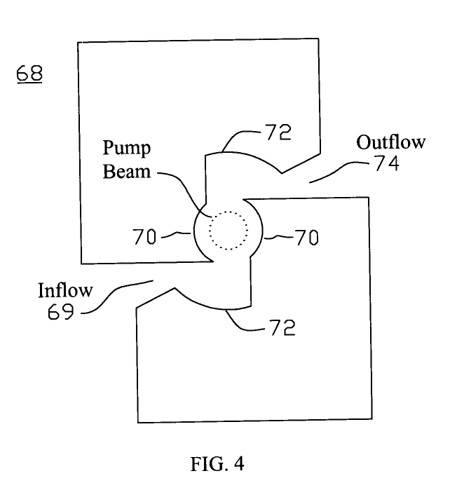

FIG. 3 is a an optical pumping system 60 for a system for producing singlet delta oxygen in accordance with one embodiment of the invention. The system contains a plurality of Yb doped fiber lasers 62. The output of the plurality of fiber lasers 62 are focused by a pair of lenses 64 on a pair of windows 66. The windows 66 cover a waveguide structure 68. The waveguide structure is show in more detail in FIG. 4.

FIG. 4 is a cross section of a reactor 68 for use in a system for producing singlet delta oxygen in accordance with one embodiment of the invention. The liquid oxygen (high pressure oxygen) enters the reactor (cyroreactor, waveguide) 68 at an input 69. The structure of the reactor 68 has essentially two reflective cavities (pair of concentric mirrors and second pair of concentric mirrors) to confine the pump light in a horizontal and vertical direction. The interior structure of the reactor 68 is coated with a dielectric material to reflect the pump light. The pair of concentric mirrors 70 is concentric and confocal with the second pair of concentric mirrors 72. The reactor 68 has an output 74 in which the excited high pressure oxygen excites the reactor 68.

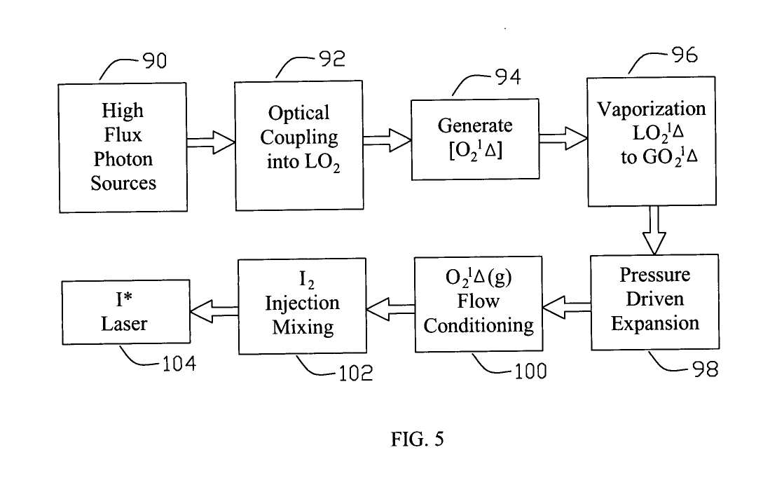

FIG. 5 is a flow chart of a system for producing singlet delta oxygen which may be used to in a laser in accordance with one embodiment of the invention. The process starts, by generating a high flux of pump photons at step 90. The pump photons are optically coupled to the liquid oxygen in the reactor at step 92. In one embodiment the liquid oxygen is cross-flowed pumped at 1 m/s absorbing the pump light and producing liquid phase singlet delta oxygen (excited state oxygen) at step 94. Sufficient heat is produced by the excitation of the liquid oxygen to vaporize the oxygen by the time it exits the reactor at step 96. The vaporization results in a pressure driven expansion (pressurizing) at step 98. In one embodiment, the pressurized oxygen is flow conditioned by a nozzle at step 100 to form a low pressure stream of excited state oxygen. Molecular iodine is mixed at the output of the nozzle at step 102. The excited dissociated iodine then lases in an optical cavity at step 104. Steps 102 and 104 are unnecessary for producing the singlet delta oxygen and are only used if a optical oxygen iodine laser is desired. Thus there has been described a system for producing high percentages of singlet delta oxygen relative to ground state oxygen that does not require large weight and volume devices and does not consume large quantities of explosive and toxic chemicals. One application for this high percentage of singlet delta oxygen is to produce a optical oxygen iodine laser which has also been described.

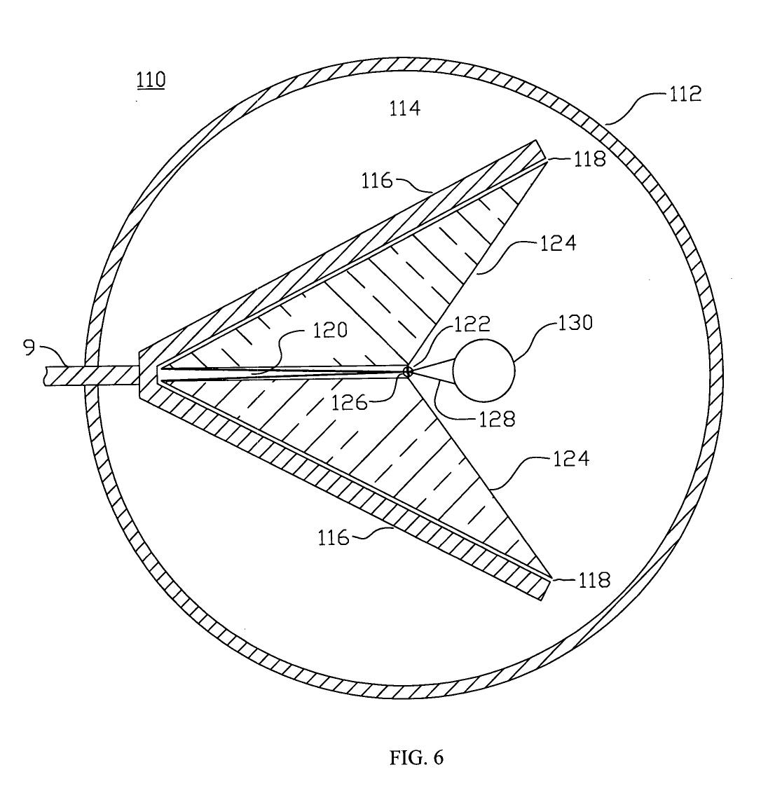

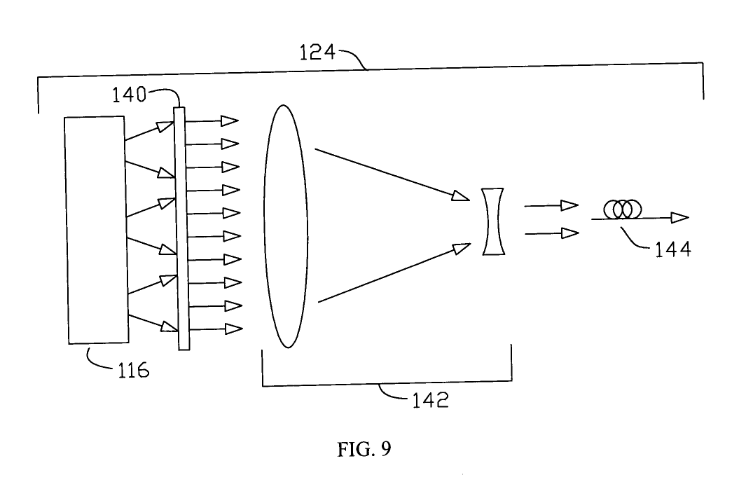

FIG. 6 is a cross sectional view of an optical oxygen laser 110, in accordance with one embodiment of the invention. The laser 110 has a double walled, vacuum sealed tank 112 that encloses a cryogenic liquid oxygen 114. The tank 112 is spherically shaped. A pair of diode arrays 116 form a V inside of the tank 112. The liquid oxygen 114 bathes and cools the diode arrays 116. The liquid oxygen 114 enters a pair of channels 118, which connect with an intake manifold 120. The liquid oxygen 114 then enters the light interaction region 122 of the cyroreactor. The light from the diode arrays 116 is coupled to light concentrators 124. An embodiment of the light concentrator 124 is described in more detail in FIG. 9. The light concentrators 124 concentrate all the light from the diode arrays into the light concentration region 122. The light excites the liquid oxygen 114 to form an excited state oxygen. Resonator mirrors 126 are placed near (or surrounding) the light interaction region 122. The resonator mirrors convert the excited state oxygen to laser light and a decayed state of oxygen. The decayed state oxygen is pushed into an exhaust manifold 128. The exhaust manifold 128 is coupled to an exhaust pipe 130. The vacuum sealed tank 112 has an opening for the exhaust pipe 130 and for the laser output light from the resonator mirrors 126. The intake manifold 120, light interaction region 122 and exhaust manifold 128 form the cyroreactor or reactor. In one embodiment, supercritical oxygen is used instead of liquid oxygen. In another embodiment, the optical pump source may be a Raman fiber laser or a ytterbium doped fiber laser. In one embodiment, the liquid oxygen 114 is at a pressure of between two and ninety atmospheres. In another embodiment the pressure of the liquid oxygen 114 is at a pressure of about 50 atmospheres. The pressure of the decayed state of oxygen in the exhaust pipe is about one atmosphere. Thus the oxygen is forced through the input channels 118, the cyroreactor 120, 122, 128 and out the exhaust pipe 130.

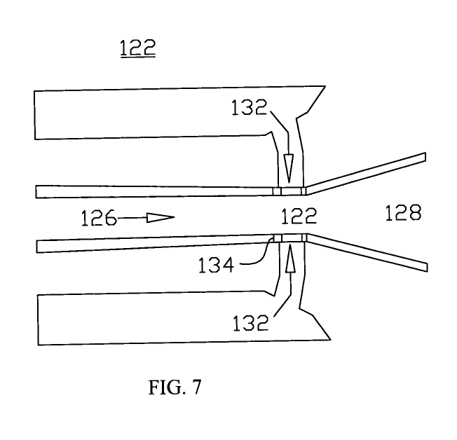

FIG. 7 is a side cross sectional view of light interaction region 122 of the optical oxygen laser of FIG. 1, in accordance with one embodiment of the invention. The liquid oxygen 114 enters the light interaction region 122 through the intake manifold 120. Concentrated light enters the light interaction region 122 through windows 132. The light is reflected inside the light interaction region 122 by reflective surfaces 134.

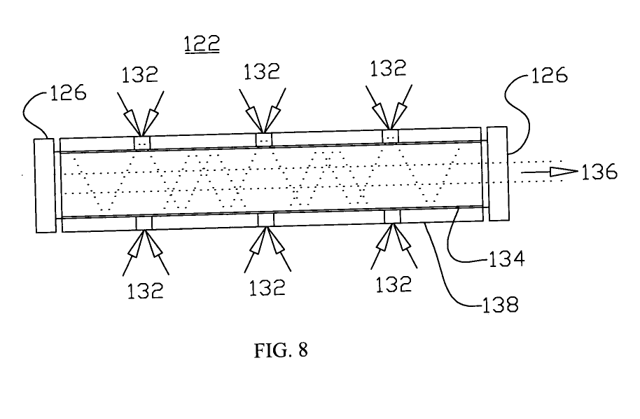

FIG. 8 is a front cross sectional view along the A-A line of the light interaction region 122 shown in FIG. 1, in accordance with one embodiment of the invention. In this view you can see that there are multiple windows 132 for the concentrated pump light to enter the light interaction region 122. The volume of oxygen is being excited by the concentrated and force out of the light interaction region 122 (or out of the paper). The ends of the light interaction region 122 are sealed by the resonator mirrors 126. The laser light 136 exits through one of the resonator mirrors 126. A hollow core fiber attached to the resonator mirror 126 allows the laser light to exit the liquid oxygen and the vacuum sealed tank 112. The highly reflective surfaces 134 form a waveguide 138 in the light interaction region.

FIG. 9 is schematic view of the optical pump source 116 and optics 124 in accordance with one embodiment of the invention. The laser diode arrays 116 are optically coupled to a diffraction element 140. The output of the diffraction element 140 is coupled through a lenses system 142 onto an optical fiber 144. The optical fiber 144 carries the light to the window 132 of the light interaction region 122. The light concentrating optics 124 are cooled by the liquid oxygen.

The method of operating the optical oxygen laser is: First, a volume of oxygen is illuminated with an optical pump source 116 in a reactor 122 to form an excited state of oxygen. Second, the excited state of oxygen is placed in an optical resonant cavity 126 having a laser output 136. Last, the decayed state of oxygen is exhausted from the optical resonant cavity. To achieve adequate gain for high power operation an oxygen density greater than 8×10ˆ21/cmˆ3 is necessary. Additionally an optical excitation intensity of greater than 5 MW/cmˆ2 is needed with an oxygen illumination time of approximately 10 microseconds to achieve the gain necessary for high power operation. Output powers of about a kilojoule per cubic centimeter of active oxygen liquid can be expected. Waste heat release into the optical medium is taken up as phase change energy in the liquid oxygen. The amount of heat release per unit volume is substantially below the amount of energy required for liquid vaporization and therefore the exhaust remains as a cryogenic fluid which vaporizes on contact with the air.

Thus there has been described an optical oxygen laser and method. In one embodiment, the laser uses the pressure differential inherent in device to flow liquid oxygen through the laser continuously. In addition, the system uses the liquid oxygen to cool the pump laser and related optics. This is the first optical oxygen laser ever designed. This is the first molecular oxygen laser ever designed. Because of its high power operation, extremely compact nature, and eye safe wavelength, it may find many uses in material processing, oil well drilling, and directed energy applications

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An optical oxygen laser, comprising:
a source of oxygen;
a cryoreactor having an input connected to the source of oxygen;
an optical pump coupled to the cryoreactor and exciting the source of oxygen to form an excited state oxygen; and
an optical resonator cavity receiving the excited state oxygen and having a laser output.

2. The laser of claim 1, wherein the source of oxygen is a liquid oxygen.

3. The laser of claim 1, wherein the source of oxygen is a supercritical oxygen.

4. The laser of claim 1, where the source of oxygen is pressurized.

5. The laser of claim 4, wherein a pressure of the source of oxygen is between two and ninety atmospheres.

6. The laser of claim 1, wherein the optical pump source is a diode array.

7. The laser of claim, 6, wherein the diode array is coupled through an optical element to an optical fiber.

8. The laser of claim 6, wherein the diode array is bathed in the source of oxygen.

9. The laser of claim 1, wherein the cryoreactor includes an intake manifold, a waveguide and an exhaust manifold.

10. The laser of claim 10, wherein the waveguide has an optical input.

11. The laser of claim 10, further including an exhaust pipe coupled to the exhaust manifold.

12. The laser of claim 11, wherein a pressure in the exhaust pipe is less than a pressure of the source of oxygen.

13. A method of operating an optical oxygen laser, comprising the steps of:
a) illuminating a volume of oxygen with an optical pump source in a reactor to form an excited state of oxygen;
b) placing the excited state of oxygen in an optical resonant cavity having a laser output; and
c) exhausting a decayed state of oxygen from the optical resonant cavity.

14. The method of claim 13, wherein step (a) includes the step of:
a1) powering a ytterbium doped fiber laser.

15. The method of claim 13, wherein step (a) includes the step of:
a1) powering a Raman fiber laser.

16. The method of claim 13, wherein step (a) further includes the step of:
a1) cooling the optical pump with a source of oxygen.

17. An optical oxygen laser, comprising:
an optical pump;
a reactor coupled to a source oxygen, the reactor combining a volume of oxygen from the source of oxygen with a light from the optical pump to form an excited state of oxygen; and
an optical resonant cavity receiving the excited state of oxygen and having a laser output.

18. The laser of claim 17, wherein the reactor has a waveguide where the light and the volume of oxygen are combined.

19. The laser of claim 18, wherein a pair of mirrors are placed at each end of the waveguide.

20. The laser of claim 17, wherein the optical pump includes a laser diode array.
